(19) United States
(12) Patent Application Publication
(10) Pub. No.: US 2012/0237758 A1
(43) Pub. Date: Sep. 20, 2012

(54) Method and Article for Concealing Labia Ridges

(76) Inventor: Lisa Hook, Glendale, AZ (US)

(21) Appl. No.: 13/417,825

(22) Filed: Mar. 12, 2012

Related U.S. Application Data
(60) Provisional application No. 61/452,473, filed on Mar. 14, 2011.

(51) Int. Cl. B32B 7/12

(52) U.S. Cl. 428/317.3

(57) ABSTRACT

A woman's disposable garment liner to smooth the surface of the female labia region for use in tight fitting clothing. The liner includes a first layer of material, a core layer for creating smooth edges of the labia and an adhesive layer for continuous hold within the preferred garment. The frontal portion includes a first end with a predetermined width and an end portion of greater predetermined width than the front end or other shape or form. The liner has tapered edges of top layer and adhesive layering sandwiching the core layer.

### CROSS REFERENCE TO RELATED APPLICATIONS

This Nonprovisional Application depends from Provisional Application: 61/452,473.

### STATEMENT REGARDING FEDERALLY SPONSORED RESEARCH OR DEVELOPMENT

Not Applicable.

### BACKGROUND OF THE INVENTION

1. Field of the Invention

The present invention relates to articles used to discreetly conceal a woman's labia ridges when wearing tight pants or similar clothing.

2. Description of Related Art

The related art includes articles such as feminine products used to protect clothing during menstruation such as “maxi pads” or “panty liners”. The present invention relates to a disposable garment liner; more specifically, it relates to a disposable method and article to conceal contours of a female's labia ridges. The purpose of the current invention is to cover the ridges of the vaginal area preventing visibility of, and concealing contours of the labial area which may be worn in various environments such as underwear, lingerie, bathing suits, leggings, gymnastics uniforms, yoga pants or any form fitting clothing that emphasize the female figure in the vaginal region. Garments which are tight against the female labia area often give the appearance of a “cameltoe”. The “cameltoe” appearance is often more noticeable when the garment has a mid-inner seam drawing unwanted attention to a women's vaginal area causing a woman to feel insecure about her appearance.

### SUMMARY OF THE INVENTION

In the preferred embodiment of the present invention, the aforementioned problem of visual privacy of the female labia ridges, or “cameltoe”, are addressed by providing a disposable garment liner having a fabric layer, core layer of silicone gel, or like thereof, and a waterproof adhesive layer having a “V” triangular shape contour for comfort in a women's garment, or another shape or form. The disposable liner is first inserted into the inner frontal crotch area of garment of choice. Placement is determined by the user's physical characteristics and preference. The liner attaches into the inner part of a garment with an adhesive backing as a single use device. The Core layer gives the garments a smooth look because of its flexible semi rigid composition. It moves and bends with the wearer, and is not visible when the wearer moves freely. The Fabric layer creates a smooth barrier between the wearer and the core, and has the ability to allow air flow and wick moisture from the wearer while maintaining its shape.

The characteristics and utilities of the present invention described in this summary and the detailed description below are not all inclusive. Many additional features and advantages will be apparent to one of ordinary skill in the art given the following drawings, specifications and claims. There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, by explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### (BRIEF) DESCRIPTION OF THE DRAWINGS

The present invention may be better understood, and its numerous features and advantages made apparent to those skilled in the art by referencing the accompanying drawings. For ease of understanding and simplicity, common numbering of elements within the illustrations is employed to identify an element in the different drawings.

FIG. 1A is a plain view of the Fabric layer and describes the tapered shape of the present invention.

FIG. 1B is a plain view of the core layer.

FIG. 1C is a plain view of the adhesive layer.

FIG. 1D is a perspective view of all layers showing how the core layer is positioned between the Fabric and adhesive layers.

FIG. 2A is a plain side view of the front portion of the article with all layers adhered together.

FIG. 2B is a plain side view of the liner with all layers are adhered together.

### DETAILED DESCRIPTION

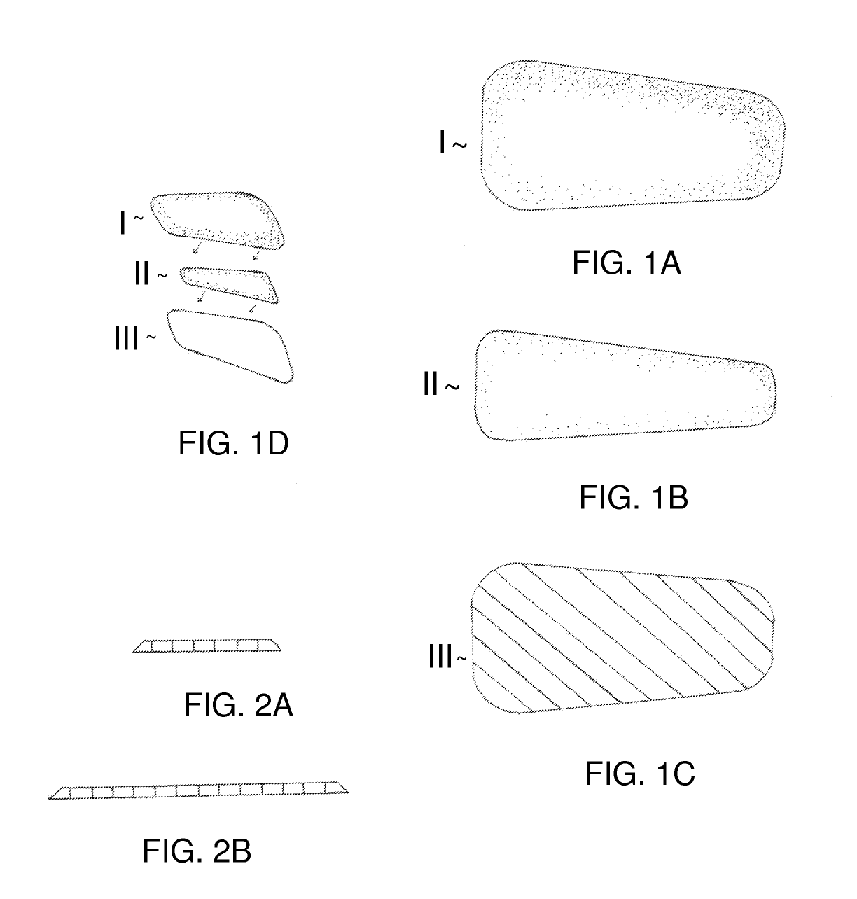

FIG. 1A is a top view of the flexible Fabric layer I of the disposable garment liner that resembles a “V” triangular shape which conforms to the wearer's body for comfort, and may have other shapes or forms. The Fabric material is comprised of a thin PU material, or any material of appropriate thickness to achieve flexibility and permeability. The Fabric layer I is adhered permanently to the Core layer II and Adhesive layer III. Fabric layer I is made of a layer of perforations for continuous air flow to reduce moisture build up on or around the labia area, and to reduce build up of bacteria.

FIG. 1B is a view of the Core II with an approximate thickness of 0.25 cm at the thickest point. The core layer II is in a slightly smaller sized “V” triangular shape, or other shape or form, so that Fabric I and Adhesive layer III are able to obtain a tapered appearance once adhered together. The Core layer II may be comprised of Silicone, Silicone Gel, or any other similar material, such as Neoprene. This Core layer II may be a clear or a tinted color to match the Fabric layer I materials. Core layer II is of a silicone material, or like thereof, for water resistance and flexibility.

FIG. 1C is the adhesive backing layer III. Adhesive backing III is comprised of the same or similar material as the Fabric layer I and is intended to adhere to the inside crotch area of a women's garment. This Adhesive layer III of waterproof single use adhesive gives the liner the capability to be submerged into water or for high sweat resistance. Adhesive layer III has the possibility to not be waterproof, giving the liner the ability to be used multiple times.

FIG. 1D is a perspective view of Fabric layer I, Core layer II and Adhesive layer III adhered together showing the tapered edging.

FIG. 2A. is a view of the front portion of Fabric layer I, Core layer II and Adhesive layer III adhered together.

FIG. 2B. is a side view of the Fabric layer I, Core layer II and Adhesive layer III after all layers are permanently adhered to make one unit.

The previous is a detailed description of illustrative embodiments of the present invention. As these embodiments of the present invention are described with references to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not to be considered in a limiting sense, as it is understood that the present invention is in no way limited to the embodiments illustrated.

What is claimed is:

1. An article and method for concealing labia ridges, comprising:
1. An article comprising a first fabric layer, a second core layer and a third adhesive layer with all three layers adhered together to form said article, and a method for using said article with clothing whereby;
said first fabric layer is comprised of perforated and/or air permeable, and water resistant material and has the capability to keep bacterial buildup from occurring;
said second core layer is comprised of silicone material or like thereof permitting flexibility, minimal memory and a thickness of approximately 1-4 mm, and may further comprise perforations or other means for ventilation and/or moisture permeability;
said third adhesive layer is comprised of fabric or other material and adhesive compounds attached to the external surface of said material comprising the bottom portion of said article; and
said method for using said article with clothing comprises exposing said third adhesive layer of said article and attaching said article via said third adhesive layer at the crotch area to the subject clothing and thereby positioning said article appropriately for use in concealing a woman's labia ridges.
